(19) United States
(12) Patent Application Publication
(10) Pub. No.: US 2010/0172456 A1
(43) Pub. Date: Jul. 8, 2010

(54) METHOD FOR ADJUSTING TRANSMISSION JITTER IN A RECEPTION TERMINAL

(75) Inventors: Didier Renaud, Paris (FR); Gaël Hendryckx, Paris (FR)

Correspondence Address: BRIGGS AND MORGAN P.A., 2200 IDS CENTER, 80 SOUTH 8TH ST, MINNEAPOLIS, MN, 55402, US

(73) Assignee: Sagem Defense Securite, Paris (FR)

(21) Appl. No.: 12/664,268

(22) PCT Filed: Jun. 10, 2008
(86) PCT No.: PCT/EP2008/057190

§ 371 Date: Dec. 11, 2009

(30) Foreign Application Priority Data
Jun. 15, 2007 (FR) 07/04267

(51) Int. Cl. H04L 25/40

(52) U.S. Cl. 375/371

(57) ABSTRACT

The invention aims to resolve the problems with jitter in a system for receiving real-time data in packets by a jitter regulation method based on the calculation of a curve representing the minimum filling rate of the buffer and by the triggering of a correction operation according to the change in this curve over time. This invention is applicable to all systems for receiving real-time data streams using a reception buffer. It is however particularly advantageous when the transmission jitter has a pseudoperiodic character.

The present invention concerns a method of regulating the jitter within a system for receiving a real-time digital data stream in packets. It applies particularly, but not limitatively, in the field of voice reception transmitted by a packet communication network such as the internet.

In this document, we define the real-time data streams as data streams transmitted to a reception terminal that consumes the data sent according to a given rhythm. It is for example the case of audio or video data streams retrieved by the terminal. When these data streams are transmitted by a packet data communication network such as the internet, the data packets transmitted do not have a delimited transmission time. As a result not all the data packets, even sent at a regular rhythm corresponding to the rhythm of consumption by the reception terminal, are received in a regular fashion by the reception terminal. As a result some packets may arrive more quickly than others, going as far as modifying the packet arrival sequence. Moreover, the transmission rhythm and the consumption rhythm cannot be perfectly synchronised, giving rise to a drift in time between the sending of the packets by the source and their reception by the terminal. These phenomena are known by the term transmission jitter.

It is known how to resolve this problem by the use of an input buffer at the reception terminal. The data packets received are accumulated in this input buffer before being transmitted to the module managing the reproduction and constituting the consumer of these data. When the system is started up, the consumer is launched only after the accumulation of a significant quantity of data in the buffer. Irregularities in the reception of the stream result in a variation in the filling rate of the reception buffer. These variations, as long as they remain within certain limits, that is to say as long as they result in neither the complete emptying of the buffer nor its complete filling, enable the consumer to consume the data received at its rhythm without blocking or loss of data. Where the buffer happens to empty, the consumer finds no more data to be consumed and retrieval stops. Where the buffer is full, new data received cannot be stored and are lost. It is therefore seen that adopting a large reception buffer makes it possible to ward against jitter. This is done however at the cost of latency.

The latter is defined by the time between the moment of sending a data packet by the source and the moment of its consumption by the consumer on the reception terminal. In a system based on a reception buffer and accepting as negligible the drift between the sending rhythm and the consuming rhythm, the latency is defined by the time necessary for accumulating data in the reception buffer before starting the consumer. The larger the buffer and the more data are accumulated in this buffer before launching the consumer, the more resistance to jitter there is but the more latency is introduced. According to the application envisaged, this latency time is prejudicial to variable extents. Whereas a video on demand application, for example, will bear a relatively long latency time of around a few seconds without appreciable prejudice for the user, this same latency time of several seconds cannot easily be borne in a telephony application. In such an application, it is necessary for a word of a speaker to be reproduced rapidly by the terminal of the other speaker. In addition, the reception buffers have a cost in the manufacture of the terminal. In this context, it is therefore sought to reduce the size of the reception buffer while seeking effective protection against transmission jitter. Buffers are therefore adopted with a size that does not perfectly guarantee against so-called famine situations corresponding to an empty buffer or saturation corresponding to a full buffer.

It is consequently necessary to adopt supplementary jitter regulation techniques in order, as far as possible, to avoid these situations of famine and/or saturation of the reception buffer.

A certain number of well known correction techniques make it possible to act on the filling rate of the buffer. Among these techniques, we can cite the fact of modifying the transmission rhythm of the data packets by the source. This modification can be controlled by the reception terminal according to the filling rate of the buffer. It is also possible, at least in certain applications, to act on the rhythm of consumption of the data by the consumer responsible for the reproduction. For example, it is possible to eliminate certain samples in an audio application or to duplicate them. While the data are manipulated in the form of data packets the size of which depends on the transmission protocol, for example IP packets for the IP protocol, these same data are manipulated in the form of samples at the level of the consumer and reproduction. The packet is the transport unit, while the sample is the semantic unit housing a meaning for the reproduction. For example, a sample will consist of an image for a video stream and a sound sample for an audio stream. The samples are transported within packets during transmission. The sound reproduction applications are capable of managing these missing or duplicated samples. The reproduction, for example of the voice, remains intelligible although degraded in its quality. This degradation is generally better perceived by the user than a break in the reproduction or loss of part of the message. A break or loss which is the result of a state of famine or saturation of the buffer. These operations of regulating the filling rate are generally triggered according to filling thresholds of the buffer. Then two thresholds are used, a low threshold and a high threshold. As soon as the filling rate of the buffer passes below the low threshold and there is therefore a threat of famine, an operation is triggered aimed at increasing the filling rate, for example by duplication of the data samples or increasing the rhythm of sending the packets by the source. As soon as the filling rate exceeds the high threshold and therefore there is a risk of saturation, an operation is triggered aimed at reducing the filling rate, for example by eliminating certain data samples or reducing the rhythm of sending of the packets by the source.

In some systems, in particular in voice transport systems on an IP network intended for mobile terminals, the last portion of communication being a wireless communication, the jitter has certain particular characteristics. The interne introduces a jitter that can be termed pseudorandom where it is difficult to predict the travel time of each packet. On the other hand wireless data communication systems used on mobile telephony networks use a burst transmission mode. The conjunction of these two types of network in the transmission introduces a jitter that can be termed pseudoperiodic, giving rise to a high pseudoperiodic variation in the filling rate of the terminal reception buffer. The use of the aforementioned jitter regulation techniques in this context leads to an excessive correction of the buffer filling rate to the detriment of the quality of the reproduction. This is because we have seen that operations aimed at acting on the buffer filling rate, for example by deleting or duplicating samples, degrade the reproduction, for example audio, of the stream received.

The invention aims to resolve the above problems by a jitter regulation method based on the calculation of a curve representing the minimum filling of the buffer and by the triggering of a correction operation according to the change in this curve over time. This invention is applicable to all real-time data stream reception systems using a reception buffer. It is however particularly advantageous when the transmission jitter has a pseudoperiodic character.

The present invention concerns a method of regulating the transmission jitter within a terminal for receiving a real-time data stream transmitted in data packets, the said terminal housing a reception buffer for storing the data samples transmitted within data packets received and a module for retrieving the said samples consuming the said samples stored in the said reception buffer comprising a step of defining a low threshold and a high threshold for filling of the said reception buffer; a step of calculating a curve relating to the change over time in the minimum of the value of the filling rate of the said reception buffer; a step of triggering a jitter correction operation aimed at reducing the filling rate of the buffer when the said calculated curve passes above the said high threshold and a step of triggering a jitter correction operation aimed at increasing the filling rate of the buffer when the said calculated curve passes below the said low threshold.

According to a particular embodiment of the invention, the step of calculating the curve relating to the change in the minimum over time is calculated for a time index N by the following steps:

the value of the curve for the index N is calculated by adding an increment to the value of the curve for the index N−1;

if this value is greater than the buffer filling rate for the index N, this filling rate is allocated to the value of the curve calculated for the index N.

The invention also concerns a method of regulating the transmission jitter within a terminal for receiving a real-time data stream transmitted in data packets, the said terminal having a reception buffer for storing the data samples transmitted within data packets received and a module for retrieving the said samples consuming the said samples stored in the said reception buffer comprising a step of defining a low threshold and a high threshold for filling of the said reception buffer; a step of calculating a curve relating to the change over time in the maximum of the value of the filling rate of the said reception buffer; a step of triggering a jitter correction operating aimed at reducing the filling rate of the buffer when the said calculated curve passes above the said high threshold and a step of triggering a jitter correction operating aimed at increasing the filling rate of the buffer when the said calculated curve passes below the said low threshold.

According to a particular embodiment of the invention, the step of calculating the curve relating to the change in the minimum over time is calculated for a time index N by the following steps:

the value of the curve for the index N is calculated by subtracting an increment from the value of the curve for the index N−1;

if this value is less than the buffer filling rate for the index N, this filling rate is allocated to the value of the curve calculated for the index N.

According to a particular embodiment of the invention, the method also comprises a step of filtering the curve relating to the change over time in the minimum of the value of the filling rate of the said reception buffer aimed at smoothing this curve and the steps of triggering the correction operations take place using the filtered curve.

According to a particular embodiment of the invention, the filtering step is carried out by applying a first order filter to the curve relating to the change over time of the minimum of the value of the filling rate of the said reception buffer.

According to a particular embodiment of the invention, the method also comprises:

a step of defining a desaturation threshold;

a step of triggering a desaturation operation when the filling rate of the said reception buffer exceeds the desaturation threshold.

According to a particular embodiment of the invention, the desaturation operation takes priority over the jitter correction operations.

According to a particular embodiment of the invention, the desaturation operating consists of the deletion of one sample out of two during the consumption of the samples of the reception buffer.

The invention also concerns a terminal for receiving a real-time data stream transmitted in data packets comprising a reception buffer for storing the data samples transmitted within the data packets received; a module for retrieving the said samples consuming the said samples stored in the said reception buffer; means of defining a low threshold and a high threshold of filling of the said reception buffer; means of calculating a curve relating to the change over time in the minimum of the value of a filling rate of the said reception buffer; means of triggering a jitter correction operation aimed at reducing the filling rate of the buffer when the said calculated curve passes above the said high threshold and means of triggering a jitter correction operation aimed at increasing the filling rate of the buffer when the said calculated curve passes below the said low threshold.

The invention also concerns a terminal for receiving a real-time data stream transmitted in data packets comprising a reception buffer for storing the data samples transmitted within the data packets received; a module for retrieving the said samples consuming the said samples stored in the said reception buffer; means of defining a low threshold and a high threshold of filling of the said reception buffer; means of calculating a curve relating to the change over time in the maximum of the value of a filling rate of the said reception buffer; means of triggering a jitter correction operation aimed at reducing the filling rate of the buffer when the said calculated curve passes above the said high threshold and means of triggering a jitter correction operation aimed at increasing the filling rate of the buffer when the said calculated curve passes below the said low threshold.

The characteristics of the invention mentioned above, as well as others, will emerge more clearly from a reading of the following description of an example embodiment, the said description being given in relation to the accompanying drawings, among which:

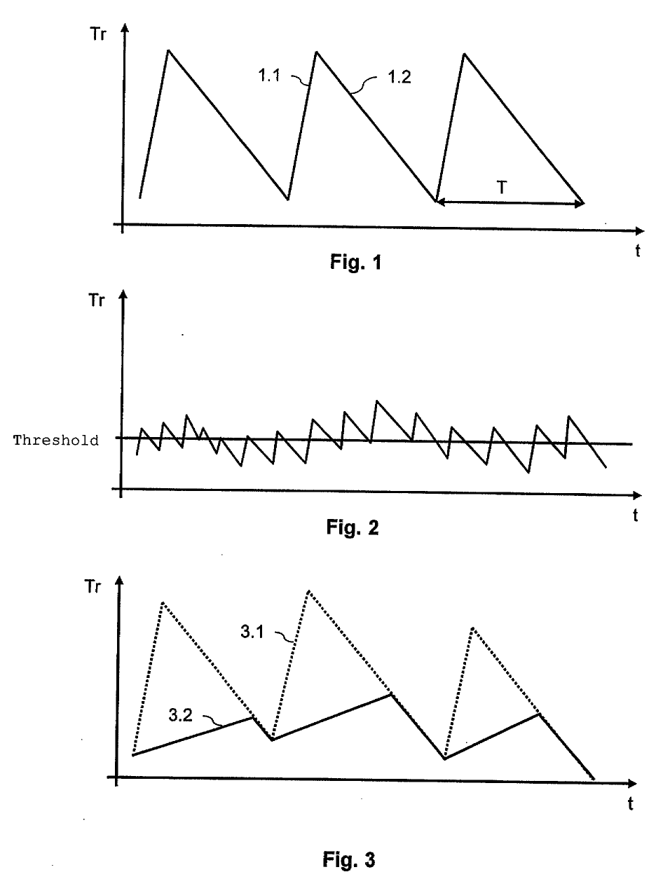

FIG. 1 illustrates an example of a pseudoperiodic component of the jitter.

FIG. 2 illustrates an example of jitter comprising a pseudoperiodic component.

FIG. 3 illustrates the calculation of a minimum peak curve according to an example embodiment of the invention.

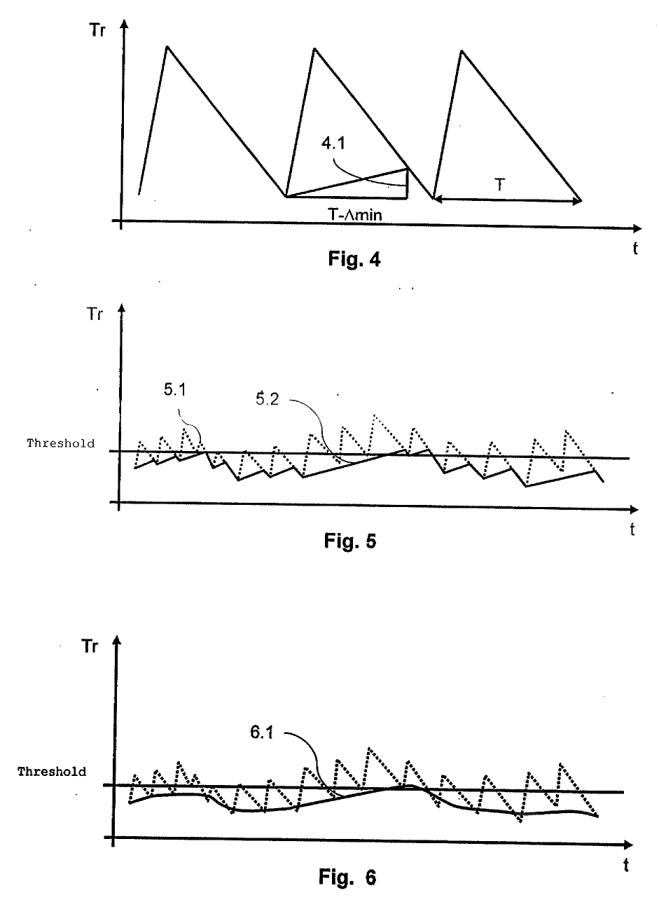

FIG. 4 illustrates the definition of the value Δ min.

FIG. 5 illustrates a minimum peak curve according to an example embodiment of the invention.

FIG. 6 illustrates a filtered minimum curve according to an example embodiment of the invention.

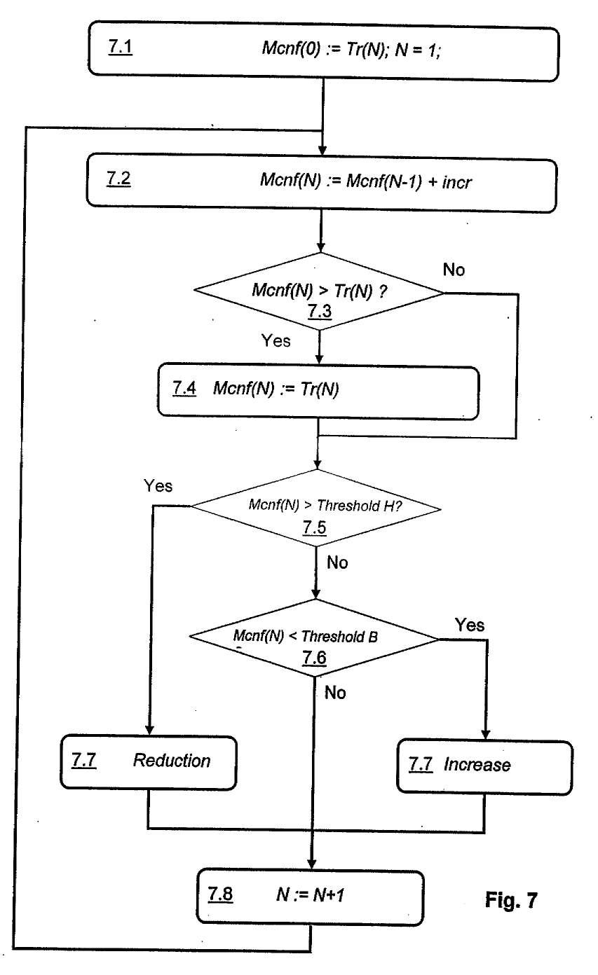

FIG. 7 illustrates the flow diagram for calculation of a minimum peak curve according to an example embodiment of the invention.

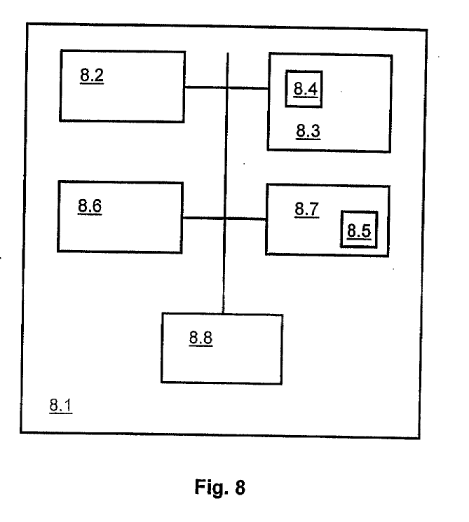

FIG. 8 illustrates an example of hardware architecture of a reception terminal according to an example embodiment of the invention.

The example embodiment of the invention that will now be described precisely is placed in the context of the transmission of voice over IP networks. In this context, the audio communication between two communication terminals is coded digitally at a terminal. It is then transmitted in the form of digital data packets containing audio samples to a second terminal. This second terminal stores the received packets in a reception buffer. A retrieval module reads the data packet in this reception buffer, decodes the audio sample and reproduces the audio signal. This module functions in a buffer sample consumption mode. This consumption takes place at a given rhythm and is therefore termed real-time.

In the example embodiment of the invention, the communication terminals are wireless terminals communicating by radio with a base station within a cellular communication network. These networks, such as the GSM (Global System for Mobile communications in English) network, are now widespread.

These networks generally provide the transmission of voice via traffic channels synchronised between the terminal and the base station. At the present time we are seeing the development of voice technologies on IP and it can more and more be envisaged allowing voice communication from these terminals via the data communication channel implementing the IP communication protocol (Internet Protocol in English). The invention is placed in this context. The communication of data packets between the two terminals therefore involve a first communication between the terminal and a base station via the IP data communication channel of a mobile telephony system. The packets are then transmitted to the second terminal via an IP communication network, generally cabled, and possibly the internet. In the case where the second terminal is also a wireless terminal, a second step of communication via the data transmission channel of a wireless telephony system is carried out. It is also possible for one of the terminals to be a cabled communication terminal having access directly to an IP network without passing through a wireless communication step.

We have already seen that the use of a generic IP network such as the internet for example tends to introduce jitter into the transmission. This jitter can be termed pseudorandom in that the shift introduced into the transmission of each packet does not statistically depend on the shifts introduced in the transmission of the other packets. The same does not apply during transmission via the channel of data of a mobile telephony network. This is because these networks have developed burst communication techniques that consist, when it is wished to transmit data at a given rate, of transmitting bursts of data at a higher rate and then cutting the transmission, these transmission and rupture steps taking place periodically in order to maintain a mean rate corresponding to the required rate. The advantage of this technique is to enable the terminal to regularly cut the power supply of its radio reception and transmission means in order to save on this energy, often supplied by battery. The systems implementing the DVB-H standard (Digital Video Broadcasting-Handheld in English), for example, function according to this principle.

The burst phenomenon can also find other origins, these being able to be combined. They may also stem from the irregularity in rate caused by the dynamic allocation of the resources shared in time in a time division multiple access or TDMA system, from the sending of data in blocks of minimum size due to the data enciphering system or to itinerance mechanisms between cells (handover in English).

Concerning the transmission jitter, these burst systems therefore introduce a periodic jitter component to the pseudorandom jitter component introduced by any IP network. FIG. 1 illustrates the profile of the jitter component introduced by the burst system displayed by the filling rate of the terminal reception buffer. The filling rate Tr of the buffer is shown on the Y axis while the time t is shown on the X axis. The rapid increase in the filling rate, represented by the portion of curve 1.1, corresponds to the reception of a burst of data packets, while the curve portion 1.2 corresponds to the consumption of the data samples by the consumer, that is to say the audio reproduction module. During this curve portion no packet is received. This curve is periodic, of period T.

The pseudorandom component due to the IP network is added to this jitter component introduced by the burst transmission mode of the data communication channel of the mobile telephony system. Then a curve is obtained whose general trend is illustrated in FIG. 2. A threshold is also drawn in this figure. It is found thereby that, when the curve approaches the vicinity of a threshold, the fact that it is “saw tooth” causes frequent passing of the threshold. Because of this, the traditional jitter regulation methods triggered by a threshold on the instantaneous filling rate of the buffer have the effect of very frequently triggering correction operations. This frequent triggering causes a degradation in the quality of reproduction of the audio signal, as we have seen.

One of the ideas at the basis of the present invention is to withdraw from the pseudoperiodic changes in the “saw tooth” curve in order to limit the triggering of the correction operations. To do this, we will define a so-called minima curve, representing the change in the minimum filling rate of the reception buffer. The jitter is then regulated according to the change in this minima curve rather than the curve of the instantaneous filling rate of the buffer.

According to a first embodiment of the invention, this curve, called the minimum peak curve, is calculated as follows: for each unit of time N an unfiltered calculated minimum Mcnf(N) is calculated.

Mcnf(N):=Mcnf(N−1)+incr;

If Mcnf(N)>Tr(N) then Mcnf(N):=Tr(N);

where Tr(N) represents the real filling rate of the buffer at time N and incr is a parameter whose value will represent the rise slope of this minimum peak curve.

The curve is initialised to the value of the curve of the minimum instantaneous filling rate, that is to say Mcnf(0):=Tr(0). The calculation method is shown diagrammatically in the form of the flow diagram in FIG. 7. In this flow diagram, a first step 7.1 consists of the initialisation and the first incrementation of the temporal index value N. This temporal index represents a unit of time that, for example, may be the elementary consumption time of a sample of sound. During a second step 7.2, the minimum peak curve is calculated by adding an increment to the previous value of the peak curve. A test is then carried out, during a step 7.3, in order to determine whether the new calculated value of the peak curve is greater that the curve of the instantaneous filling rate. In the case where this test is true, the new value of the minimum peak curve calculated is the value of the instantaneous filling rate of the buffer, this is done during a step 7.4. The calculated value is then tested with respect to a high threshold during a step 7.5, if it is higher an operation is triggered, during a step 7.7 aimed at reducing the size of the buffer, for example by the elimination of samples in the buffer. If the test of step 7.5 is negative, the calculated value is then tested with respect to a low threshold during a step 7.6, if it is less an operation is triggered, during a step 7.8, aimed at increasing the size of the buffer, for example by the duplication of samples in the buffer. The temporal index is then incremented, followed by resumption at step 7.2.

This first embodiment is shown in FIG. 3, where the curve Tr(N) is shown in a dotted line and referenced 3.1 while the minimum peak curve is referenced 3.2. It can be seen that this curve has a linear increasing slope when it is under the curve Tr(N), a slope determined by the value of the parameter incr, while it follows the curve Tr(N) otherwise. The change over time in this minimum peak curve gives a curve indicating the change in the minimum filling of the buffer over time.

The parameter incr is chosen according to the desired reactivity and the real variations in this minimum. This is because the greater the rise slope the more possible it will be to follow large variations in this filling minimum, but the more this minimum peak curve will be in a “saw tooth” and will present the same drawbacks as the curve of the instantaneous filling rate. An excessively low value of this slope will make it difficult to follow, upwards, the minimum filling. In the example embodiment, values of the parameter incr giving a slope close to 10% have given good results. When the unit of time curve used for calculating the curve is the time necessary for the consumer to consume a packet, that is to say, in the case of an audio decoder, the time necessary for decoding a sample of sound, the portion of curve 1.2 has a slope descending at 45%. In this context, the slope of the minimum peak curve can be expressed as being dependent on a value Δmin referenced 4.1 in FIG. 4, the slope is therefore:

incr:=Δmin(T−Δmin).

Expressed in this way, Δmin will advantageously be chosen less than the difference between the two thresholds, the high threshold and the low threshold, of triggering of the correction operations.

FIG. 5 illustrates the impact of the calculation of such a minimum peak curve when the latter is used conjointly with a threshold. There are found in the figure the curve representing the real filling rate of the buffer as a function of the time Tr(N) referenced 5.1 and the calculated minimum peak curve referenced 5.2 as well as the threshold illustrated by the straight line parallel to the X axis. It can be seen immediately that the calculated minimum peak curve exhibits the so called “saw tooth” aspect less than the curve of the filling rate, the consequence of which is that it crosses the threshold less often. It can be said that the curve is smoother. It represents the general change in the curve of the filling rate, apart from the peaks due to the burst transmission mode. Consequently, in this embodiment, the minimum peak curve thus calculated is used, instead of the curve of the instantaneous filling rate of the buffer, conjointly with two threshold values, a high threshold and a low threshold, for triggering the correction operations allowing regulation of the jitter.

It should be noted that the method thus proposed does not offer a drawback in the case where the jitter does not offer any pseudoperiodic variation, for example in the case where the transmission does not follow the channel implementing a burst transmission. In such a case, the method according to the invention will behave like the conventional method using the curve of the instantaneous filling rate of the buffer conjointly with two thresholds as a trigger for the jitter correction operations. It is therefore possible to use the invention in all cases and in the absence of prior knowledge on the characteristics of the jitter.

According to a variant implementation of the invention the minimum peak curve is filtered in order further to minimise the peaks that it presents. The technical effect of this filter is to smooth the curve without changing its general trend. This is because the smoother the curve, the fewer roughnesses it will exhibit and the more the crossings of the thresholds will represent a real need for correction in order to avoid famine or overflow of the buffer. To do this, it is possible to apply, for example, a first level filter to the curve. If the filtered minima curve is termed Mf(N), the minimum peak curve Mcnf(N) always being calculated according to the method described above, the filter can be calculated in the following manner:

Mf(N):=Mf(N−1)+(Mcnf(N)−Mf(N−1)/Trep;

where Trep represents a parameter called the response time of the filter. This parameter must be chosen between the value of the typical period of the pseudoperiodic component of jitter and half of it. That is to say, if the typical period, illustrated in FIG. 1, is called T, Trep must be between T and T/2. This filtered curve is illustrated by the curve 6.1 in FIG. 6. It can be seen in this figure that the number of occurrences of crossing between the curve obtained and the threshold decreases further.

A person skilled in the art will understand that any other type of filter making it possible to smooth the curve can be applied instead of the first order filter of the example embodiment without departing from the scope of the invention. It is also possible to apply the same method to the maxima instead of the minima. In this case, the slope of the maxima peak curve is chosen decreasing instead of increasing and is maintained above rather than below of the curve of the instantaneous filling rate of the buffer. The maximum peak curve Maxcnf will for example satisfy the following equations:

Maxcnf(N):=Maxcnf(N−1)−incr;

If Maxcnf(N)<TR(N) then Maxcnf(N):=Tr(N).

It can be seen that the method proposed makes it possible advantageously to manage the pseudoperiodic jitter component offering the same level of performance on the other jitter components that may be involved.

It makes it possible to erase the variations in high frequency and limited amplitude in the filling rate of the buffer. On the other hand, it may happen that transmission on IP causes occasional saturation resulting in a long period without reception of packets followed by a rush of data. This may for example occur during a change of cell (handover in English) or following overcrowding at a router on the transmission network. Such saturation causes an isolated high-amplitude variation in the filling level of the buffer. Because of the damping afforded by the previously described method, the recovering from such a saturation is relatively slow.

According to a variant implementation of the invention, so as to mitigate these saturations, a mechanism for managing these saturations is advantageously coupled with the previously described mechanism. For example a high threshold for triggering a correction operation called accelerated suppression is set up on the curve of the instantaneous filling rate of the buffer. Here this instantaneous filling rate curve is used rather than the minimum curve, or maximum curve, calculated so as to reduce the reaction time to such a saturation. Because of the isolated nature of such a variation to be corrected, a rapid reaction time does not give rise to an excessive correction as is the case during the correction of the pseudoperiodic component using the instantaneous filling rate curve. As soon as the instantaneous filling rate therefore exceeds this saturation threshold, a correction operation, for example the suppression of one sample out of two during consumption, is undertaken until the filling rate goes below the saturation threshold again. This strong correction is audible but does not compromise the understanding of the voice and makes it possible to return the instantaneous filling rate of the buffer quickly below the saturation threshold. When it is put in place, this saturation recovering action takes priority over the correction operations triggered by the passing of a threshold by the curve relating to the minimum or maximum.

FIG. 8 depicts the hardware architecture of a reception terminal 8.1 according to an example embodiment of the invention. This terminal comprises a network interface 8.2 permitting the reception of data packets. This interface 8.2 communicates with a random access memory module 8.3, which comprises the reception buffer 8.4. The terminal also comprises read only memory 8.7, which comprises the various programs 8.5 implementing the method according to the example embodiment of the invention as well as the consumer. These programs can be loaded in the random access memory 8.3 with a view to their execution. The terminal functions under the control of a processor 8.6 responsible for the execution of the program 8.5 and the various operations of the terminal. The data stream received and stored in the reception buffer 8.4 is then consumed by the reproduction module that controls the reproduction member 8.8, which may be a loudspeaker in the case of audio reproduction or a screen for a video stream.

1. A method of regulating the transmission jitter within a terminal receiving a real-time data stream transmitted in data packets, the said terminal having a reception buffer for storing the data samples transmitted within data packets received and a module for reproducing the said samples consuming the said sample stored in the said reception buffer, comprising the following steps:
(a) defining a low threshold and a high threshold for filling of the said reception buffer characterised in that it also comprises:
(i) a step of calculating a curve relating to the change over time in the minimum of the value of the filling rate of the said reception buffer;
(ii) a step of triggering an operation of correcting the jitter aimed at reducing the filling rate of the buffer when the said calculated curve passes above the said high threshold; and
(iii) a step of triggering an operation of correcting the jitter aimed at increasing the filling rate of the buffer when the said calculated curve passes below the said low threshold.

2. The method of claim 1, wherein the step of calculating the curve relating to the change over time in the minimum is calculated for a temporal index N by the following steps:
(a) the value of the curve for the index N is calculated by adding an increment to the value of the curve for the index N−1; and
(b) if this value is higher than the filling rate of the buffer for the index N, this filling rate is allocated to the value of the curve calculated for the index N.

3. A method of regulating the transmission jitter within a terminal receiving a real-time data stream transmitted in data packets, the said terminal having a reception buffer for storing the data samples transmitted within data packets received and a module for reproducing the said samples consuming the said sample stored in the said reception buffer, comprising the following steps:
(a) defining a low threshold and a high threshold for filling of the said reception buffer characterised in that it also comprises:
(i) a step of calculating a curve relating to the change over time in the maximum of the value of the filling rate of the said reception buffer;
(ii) a step of triggering an operation of correcting the jitter aimed at reducing the filling rate of the buffer when the said calculated curve passes above the said high threshold; and
(iii) a step of triggering an operation of correcting the jitter aimed at increasing the filling rate of the buffer when the said calculated curve passes below the said low threshold.

4. The method of claim 1, wherein the step of calculating the curve relating to the change over time in the minimum is calculated for a temporal index N by the following steps:
(a) the value the curve for the index N is calculated by subtracting an increment from the value of the curve for the index N−1; and
(b) if this value is less than the filling rate of the buffer for the index N, this filling rate is allocated to the value of the curve calculated for the index N.

5. The method of claim 1, characterised in that it also comprises a step of filtering the curve relating to the change over time in the minimum of the value of the filling rate of the said reception buffer aimed at smoothing this curve and in that the steps of triggering the correction operation are implemented from the filtered curve.

6. The method of claim 5, wherein the filtering step is performed by applying a first order filter to the curve relating to the change over time in the minimum of the value of the filling rate of the said reception buffer.

7. The method of claim 1, characterised in that it also comprises:
(a) a step of defining a desaturation threshold; and
(b) a step of triggering a desaturation operation when the filling rate of the said reception buffer exceeds the desaturation threshold.

8. The method of claim 7, wherein the desaturation operation takes priority over the jitter correction operations.

9. The method of claim 7, wherein the desaturation operation consists of the elimination of one sample out of two during the consumption of the samples of the reception buffer.

10. A terminal for receiving a real-time data stream transmitted in data packets, comprising:
(a) a reception buffer for storing the data samples transmitted within the data packets received;
(b) a module for reproducing the said samples consuming the said sample stored in the said reception buffer; and
(c) means of defining a low threshold and a high threshold for filling the said reception buffer characterised in that it also comprises:
(i) means of calculating a curve relating to the change over time in the minimum of the value of the filling rate of the said reception buffer;
(ii) means of triggering a jitter correction operation aimed at reducing the filling rate of the buffer when the said calculated curve passes above the said high threshold; and
(iii) means of triggering a jitter correction operation aimed at increasing the filling rate of the buffer when the said calculated curve passes below the said low threshold.

11. A terminal for receiving a real-time data stream transmitted in data packets, comprising:
(a) a reception buffer for storing the data samples transmitted within the data packets received;
(b) a module for reproducing the said samples consuming the said samples stored in the said reception buffer; and
(c) means of defining a low threshold and a high threshold for filling the said reception buffer characterised in that it also comprises:
(i) means of calculating a curve relating to the change over time in the maximum of the value of the filling rate of the said reception buffer;
(ii) means of triggering a jitter correction operation aimed at reducing the filling rate of the buffer when the said calculated curve passes above the said high threshold; and
(iii) means of triggering a jitter correction operation aimed at increasing the filling rate of the buffer when the said calculated curve passes below the said low threshold.
